(19) United States
(12) Patent Application Publication
(10) Pub. No.: US 2017/0215519 A1
(43) Pub. Date: Aug. 3, 2017

(54) Removable rubberized pointe shoe caps for non-traditional studio and other flooring

(71) Applicant: Maura Ann McHugh, Stamford, CT (US)

(72) Inventor: Maura Ann McHugh, Stamford, CT (US)

(21) Appl. No.: 15/010,898

(22) Filed: Jan. 29, 2016

(51) Int. Cl. A43B 5/12; B29D 35/12; A43B 5/18

(52) U.S. Cl. CPC A43B 5/12; A43B 5/18; B29D 35/12

(57) ABSTRACT

While taking notice how a dancer's pointe shoe keeps them from dancing on hardwood, as it is dangerous, I decided to create a rubber cap for the shoe. It is removable in order to keep the dancer from having to spend the money on a new pair of shoes and instead being able to put the cap over their current pair of shoes. The process of making this involves many molds and the final product is a silicone rubber cap the fits each unique shoe.

The problem I am trying to solve in this process is the finding of an easier way to gain safety while dancing on pointe on hard wood flooring. Many dancers travel to more places rather than just a stage, but also places like hotels, which don't have the correct flooring and instead have hardwood. It is not safe for dancers to dance on pointe on hardwood flooring. Dancers dance on Marley flooring because it creates enough friction so that it is not dangerous to dance on pointe. A dancer has two types of shoes: pointe shoes and flat shoes. It is safe to dance in flat shoes on hardwood. A ballet dancer's two options when having to dance on hardwood is to dance in flat shoes, or rubberize their pointe shoes so that it is safe to dance in them. When a dancer rubberizes their pointe shoes they cannot take off the rubber when they are done dancing. This means they must buy a new pair of pointe shoes. This costs a lot of money. This problem can be solved if the rubber was removable.

In order to do this project I used many molds and the final product was made out of silicone rubber. First I made a mold of the outside of the shoe with silicone putty. Then I made a plaster mold of the shoe by pouring the plaster inside of the silicone putty mold. This caught all the tiny details the shoes had. Then I poured silicone rubber over the plaster mold. When this dried I could cut it into the shape I wanted to get the final product.

This would make the rubberizing pointe shoes process easier because they can be removed or placed back on when needed. It takes away the struggle of having to buy a new pair of pointe shoes and then having two pairs. It still reaches the goals of its job, which is to keep the shoe from being slippery on hardwood. Overall this product is a lot more convenient. In the end this project was successful in being removable and keeping dancers from falling when they dance on pointe on hard wood flooring.

### FIELD

My invention is a removable slip made of rubber that goes over the pointe shoe (a dancer's shoe) so that they will not slip on non-traditional studio flooring. This is for dancers who travel to hotels and other places that may not have Marley (studio flooring- FIG. 1) as flooring for the stage. It is possible to rubberize the pointe shoe, however this is permanent and cannot be removed. It also has a price and also means the purchase of a new pair of pointe shoes, which can be expensive. Because Marley already creates enough friction for a regular pointe shoe, you wouldn't be able to just have one pair of rubberized ones because it would create too much friction. Unlike this, my invention is able to be removed from the shoe when not needed and would save money.

### BACKGROUND

My first thought of this idea happened when my ballet school had planned to perform at a hotel. This hotel did not have our usual flooring and instead had hard wood. It wasn't a particularly hard dance so we tried practicing it before the show on hard wood with our pointe shoes. There are two different shoes a dancer uses. One of the shoes are ballet flats (FIG. 2) and the other are pointe shoes (FIG. 3). The pointe shoes allow the dancer to go up on her toes. It is a beautiful art in ballet but however is dangerous to do on non-studio flooring. When we were unable to practice in our pointe shoes on the hard wood we performed in our flats. Still a good show but what we did was missing the art of pointe shoes. My school doesn't usually travel to hotels to dance so there was no point in rubberizing our pointe shoes and having to spend the money. However there are many dancers who travel a lot to dance. This is when I realized the problem could be solved if the rubber that is put on the shoe when rubberizing pointe shoes could be removable.

### SUMMARY

This project of the rubberized pointe shoe caps did take a few tries with some failed attempts, but in the end it only took a series of steps to finish. My materials included plaster, silicone putty, silicone rubber, and a pointe shoe. First I covered the box of the pointe shoe (FIG. 4), front of pointe shoes (FIG. 5), and part of the bottom of the pointe shoes (FIG. 6) with silicone putty (FIG. 9). The silicone putty is like Play- Doh, is easy to mold and captures every detail. When the mold dries, on the inside there is a replica of the outside of the shoe (FIGS. 7 and 8). I then filled the mold with plaster (FIG. 10) and when this dried it created another replica of the shoe (FIG. 11). I then took this mold and I poured the silicone rubber (FIG. 12) over it (FIG. 13). When this was dry I peeled the rubber off of the mold and cut it with scissors into the shape I wanted (FIG. 14). Because I wanted the cap to be tight on the pointe shoes I used a mold of a pointe shoes a few sizes smaller than the one the cap would be tested on. Every dancer's shoe is unique. When they first buy the shoe, it is new and just the same as any other shoes of the same brand. However once the dancer starts to use the shoe it becomes different than the other ones. The box of the shoe might be more broken in on one side than the other according to the way the dancer dances. This is why it would be better to use an old pair of pointe shoes to make the molds for the rubber cap. Most dancers stay with the same shoe for pointe shoes because different dancers have different shoes according to their strength in their feet. For example one who has a better and stronger pointe in their feet might have a stronger box on their shoe.

### DESCRIPTION OF DRAWINGS

FIG. 1 is Marley flooring. This is studio flooring, which has rubber in it, and allows dancers to use regular pointe shoes without the addition of rubberizing it.

FIG. 2 is a pair of flat shoes. These shoes dancers use for class and warm ups. They do not allow the dancer to go on pointe, only half pointe.

FIG. 3 is a pair of pointe shoes. This is another shoe ballet dancers use to go on pointe, or on their toes. These shoes can only be used on studio flooring unless they are rubberized.

FIG. 4 a part of the shoe that is important and must be covered by the rubber cap.

FIG. 5 the front of the pointe shoe is another part of the shoe that is covered by the rubber cap and helps the product stay on the shoe.

FIG. 6 the bottom of the pointe shoe is important but only needs to be covered part of the way. It is not necessary for the cap to cover all of the bottom/sole of the pointe shoe.

FIGS. 7 and 8 show the inside of the silicone putty mold. This mold captures the outside of the pointe shoe.

FIG. 9 is the silicone putty. This is silicone putty that is in the form of something almost like dough. It can be molded and shaped into what you want.

FIG. 10 is the plaster. I used this to create the second mold that looked like an exact replica on the pointe shoes.

FIG. 11 is the plaster mold vs. the real pointe shoes. This shows how the plaster captures very specific details, which is very important in the process of making this product.

FIG. 12 shows the silicone rubber. This is liquid and is used as one of the final steps to making the rubber caps. It can be easily cut and is poured on the plaster mold to create the shape.

FIG. 13 shows the silicone rubber over the plaster mold. This shows how the shape of the cap is made.

FIG. 14 shows the finished product. This is the final outcome after these series of steps.

FIG. 15 shows the box of the shoe with the torn fabric. This is the reason why I couldn't just pour the silicone onto the shoe.

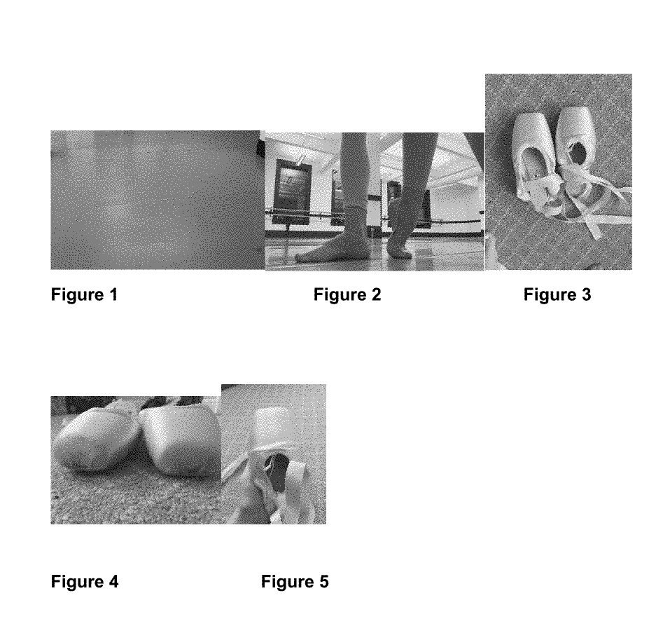

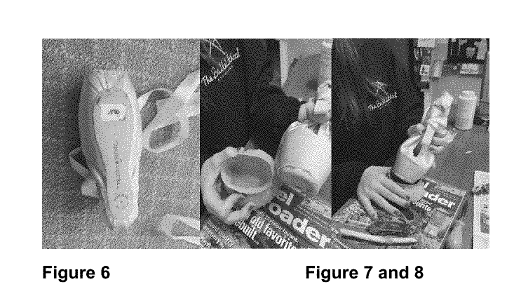

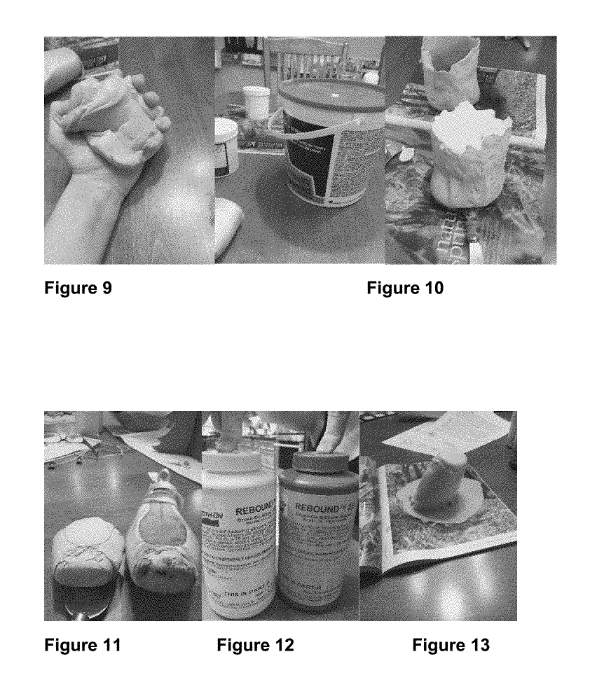

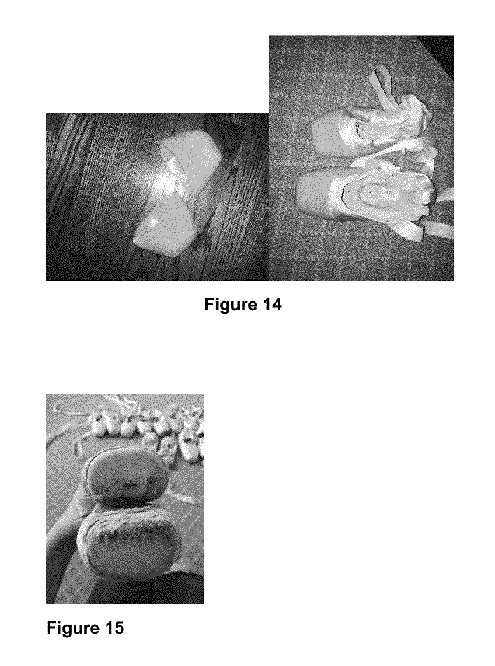

### DETAILED DESCRIPTION

My idea of the removable caps did take a few tries. First I didn't need to use the silicone putty or the plaster. I just poured the silicone on the pointe shoe. This did not work because it turned my pointe shoe pink and because pointe shoes get worn out and tear at the box (FIG. 15). Pointe shoes have a silk- like fabric exterior finish. So when pointe shoes are worn for a while they tear at the box. Therefore, when I poured the silicone rubber on the shoe it went in between the shoe and the fabric on the outside and it dried. This made it impossible to take the rubber off of the shoe. I had to cut it off. I thought of this idea but realized it wouldn't work and that my next procedure would work. I thought maybe I could put the silicone putty on the outside of the pointe shoes and then pour the silicone rubber on top of that. This would not work because the silicone putty is like dough. It would capture every fingerprint. This would make it not an exact replica of the pointe shoe. I never tested this procedure because I knew in my head it would not work out and fit the shoes the way it is supposed to. And then, my final procedure, was successful. The procedure forms the silicone putty on the outside and filling it with plaster to make a mold. Then pouring the silicone rubber on the plaster mold and cutting it into the shape I wanted.

What I claim is

1. Pointe shoes with removable rubberized caps;
Removable rubberized caps that are unique to an individual dancer's pointe shoes;
A tight fit unique to the dancer;
Removable rubberized caps created in this way;
A procedure using the following steps: Silicone putty formation on the outside, a plaster mold replica from the silicone putty formation, silicone rubber on the plaster to make a removable rubberized pointe shoe cap.
